(19) United States
(12) Patent Application Publication
(10) Pub. No.: US 2016/0259911 A1
(43) Pub. Date: Sep. 8, 2016

(54) Automated Medication Adherence System

(71) Applicant: Danny P. Koester, Evansville, IN (US)

(72) Inventor: Danny P. Koester, Evansville, IN (US)

(21) Appl. No.: 14/636,570

(22) Filed: Mar. 3, 2015

(51) Int. Cl. G06F 19/00

(52) U.S. Cl. CPC G06F 19/3456; G06F 19/3418; G06F 19/3406

(57) ABSTRACT

An automated medication adherence system designed for confirming compliance with a prescribed medication regimen that provides immediate verification of adherence by visual analysis. The system includes at least one remote device and a central computer. Each remote device as well as the central computer include means for receiving a video feed over a network connection such that a patient located at a remote device can use its video camera to bi-directionally communicate with an operator located at the central computer. In application, the patient faces the video camera so that the operator at the central computer can witness the patient administering the medication. Further, during the entire administering session, neither the medication container nor the dosage is ever removed from the view of the camera and the operator stationed at the central computer so that while the prescribed medication is being administered by the patient, the medication remains in front of the camera until completely administered by the patient.

### CROSS REFERENCES TO RELATED APPLICATIONS

None

Statement as to rights to inventions made under federally sponsored research and development Not Applicable.

### BACKGROUND OF THE INVENTION

1. Field of the Invention

The invention relates generally to the monitoring of a person's compliance with a prescribed medication regimen, and more particularly to an automated system for monitoring and verifying a person's compliance with a prescribed medication regimen by visual analysis using video conferencing technology between a remote device and a central computer.

2. Brief Description of Prior Art

Medical professionals often treat patients by prescribing a medication regimen designed to improve or stabilize a medical condition, insure compliance with a court-ordered rehabilitation program, to maintain the quality of life or to provide relief after the patient has suffered a trauma or is undergoing late stage illness treatment. A medication regimen typically includes instructions for a patient to ingest a prescribed medication at a specific dosage and at prescribed time intervals. The effectiveness of such medication regimens often depends on how well the patient complies with the instructions of the regimen. For example, if the patient does not ingest the medication at the prescribed time intervals or dosage, the medication regimen may be ineffective or even harmful to the patient.

Medication adherence usually refers to whether patients take their medications as prescribed, as well as whether they continue to take a prescribed medication. Medication adherence is a growing concern to healthcare systems, and other stakeholders because of mounting evidence that nonadherence is prevalent and associated with adverse outcomes and higher costs of care. Medication nonadherence is likely to grow as the population ages and as patients take more medications to treat chronic conditions.

Patients or program recipients can fail to adhere to a medication or other dosage regimen for a variety of reasons. For example, elderly patients often forget to take medication or become confused because of the complexity of simultaneously taking multiple medications or adhering to multiple medication regimens or changing dosage requirements, e.g. increasing or decreasing the amounts of the medication. As another example, patients often fail to adhere to medication regimens because of the costs of a particular medication or a combination of medications, fear of side-effects, underestimating the severity of a medical condition, misunderstanding instructions or just a general desire not to take the medication.

Failure to adhere to a medication regimen can result in prolonged recovery time, deterioration of the medical condition, increased risk of new medical problems, increased medical costs or other undesired or unintended consequences.

In addition, and in some instances, a patient requires supervision when complying with the prescribed medication regimen, and is asked to travel to a controlled environment such as a medical facility or laboratory. Persons on rehabilitation programs, for example, are required to regularly “report” to controlled areas for medication adherence which is inconvenient at best, and often difficult due to transportation restraints and the like.

What is needed is an inexpensive, efficient and reliable means to monitor and verify that the patient is in compliance with a prescribed medication regimen. What is further needed is such a medication adherence system that, when relevant, avoids the expense and inconvenience of requiring the patient to travel to an off-site environment.

As will be seen from the subsequent description, the preferred embodiments of the present invention overcome shortcomings of the prior art, and provides a system to confirm compliance with a medication regimen in order to further the well-being of the patient.

### SUMMARY OF THE INVENTION

An automated medication adherence system designed for confirming compliance with a prescribed medication regimen that provides immediate verification of adherence by visual analysis. The system includes at least one remote device that is connected to a network connection such as the Internet for permitting a testing subject to connect with a central computer of the system. Each device as well as the central computer include video conferencing equipment. By receiving a video feed over a network connection like a hard-wire or wireless Internet connection, a testing subject located at a remote device can use its video camera to bi-directionally communicate with a person located at the central computer by audio and video.

In application, an operator at the central computer accesses the automated medication adherence system, and, the patient connects to the network connection and accesses communication with the system from the remote input device. The operator instructs the patient to place a medication container and/or an actual pill or other prescribed medication for the patient directly in front of the lens of the imaging device or camera. Once the prescribed medication is in clear view, the operator can remotely capture a current electronic photograph of the medication. The operator visually compares the current electronic photograph of the medication displayed by the patient with the currently prescribed medication listed in the patient's profile. If the operator can confirm that the medication displayed by the patient is the prescribed medication for the patient, the patient is instructed to open pre-packaged medication, or allow the medication to drop or pour into a medicine cup. The operator then visually verifies appropriate quantities, dosage according to the prescription guidelines noted in the patient's profile.

Next, the patient is prompted to administer the prescribed medication. The operator observes the patient administer the medication, and may verify that the patient has completed administering the prescribed medication. For purposes of compliance and integrity, it is critical that during the entire administering session, neither the medication container nor the dosage is ever removed from the view of the camera and the operator stationed at the central computer.

### BRIEF DESCRIPTION OF THE DRAWINGS

FIG. 1 shows a flow chart of an automated medication adherence system, consistent with an embodiment of the present invention.

### DESCRIPTION OF THE PREFERRED EMBODIMENT

In accordance with the present invention, an automated medication adherence system is disclosed. The invention relates to monitoring of a patient's compliance with a prescribed medication regimen, and a method for inexpensively electronically monitoring, verifying, and if need be, reporting such compliance. The described system allows for complete control and verification of adherence to a prescribed medication regimen, whether in a healthcare provider's care, in compliance with a court-ordered program, or when administered in a homecare situation. In any case, the present disclosure provides a system to confirm that the medication is being actually and properly taken. In the broadest context, the automated medication adherence system of the present invention consists of components configured and correlated with respect to each other so as to attain the desired objective.

In the preferred embodiment, at least one remote device is connected to a network connection such as the Internet for permitting a patient to communicate with a central computer of the system. In other embodiments, other means of electronic communication may be used.

In application, the patient must first personally enroll in the system before using. When enrolling with the system, the patient may provide a profile that can include the subject's name, and can also include the subject's address, telephone number, and so forth, In addition, the system may require an electronic photograph be taken and stored in the subjects profile. The electronic photograph is preferably a full, frontal facial of the patient subject.

The patient profile may further include instructions about the particular medication(s) the patient is prescribed, including methods for ingestion. It is further contemplated in accordance with the invention that these instructions may comprise written, audio or video instructions. Such instructions, as will be described below, allows the operator at the central computer to correctly monitor the patient in a manner consistent with the prescribed medication instructions.

The patient's profile is stored in the central computer. In application, when the patient is in communication with the central computer, in the preferred embodiment, the patient is allowed access to the system by looking directly at the imaging device so that the operator at the central computer can compare the patient's full, frontal facial with the full, frontal facial electronic photograph stored with the subject's profile. In the alternative, the patient can be allowed access to the system by entering its name from the remote device or, the system may further assign a unique PIN number to the subject and access is granted by entering its assigned PIN number.

Each remote device as well as the central computer include an “imaging device” tethered (or connected hard-wired or wireless), The “imaging device” means equipment for conducting a “video call” where the remote device and central computer are connected to the network connection. For example, the imagining device may be a web camera, video conferencing device, or video device.

The imaging device may further be a smartphone or other mobile handheld wireless computerized communications device having standard smartphone functionality such as a video camera, and Wi-Fi transceivers, and may be implemented in the form of a standard smartphone app.

As should be understood, by receiving a video feed over the network connection, a patient located at a remote device can use its video camera to bi-directionally communicate with a person located at the central computer by audio and video.

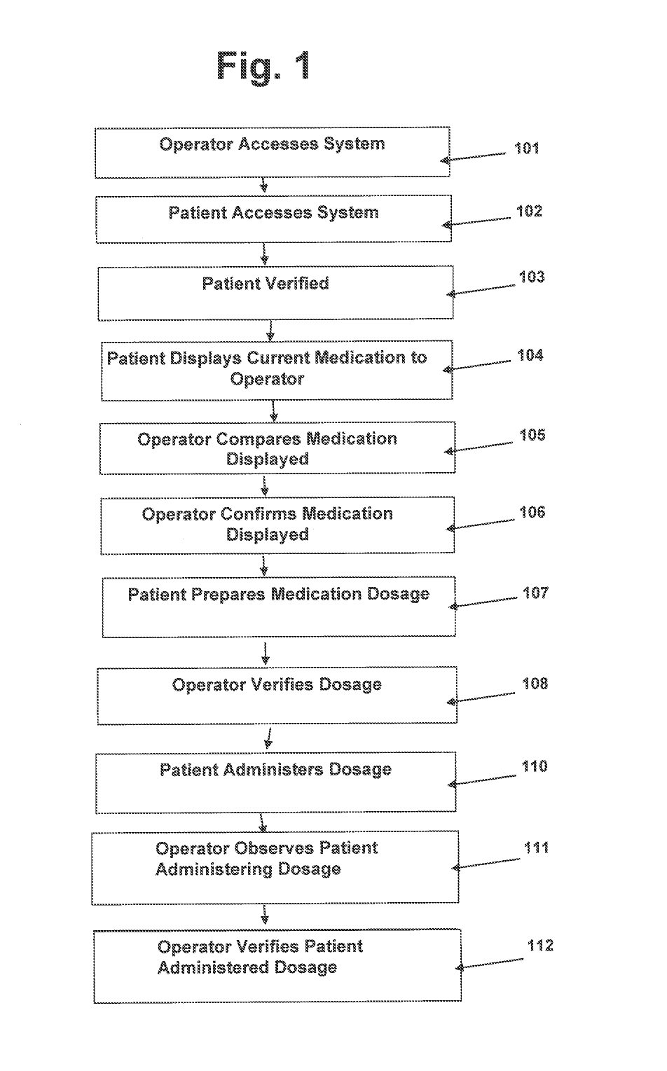

An example of various steps involved in monitoring and verifying a patient's adherence with a prescribed medication regimen, and the steps required of the present invention, is illustrated in the flow chart of FIG. 1. Although the blocks of the flow chart are discussed and numbered in a certain order, they need not necessarily be performed in that order.

At step 101, an operator at the central computer logs into or accesses the automated medication adherence system. The central computer is connected to the network connection, such as the Internet.

At step 102, the patient connects to the network connection and accesses communication with the system from the remote input device as earlier described. In the preferred embodiment, the patient is avowed access to the system by looking directly at the remote imaging device such that the operator can visually compare the patient's current full, frontal facial with the full, frontal facial electronic photograph in the patient's profile. Once the identity of the patient is verified at 103, the patient will then be in communication with the automated mediation adherence system.

As previously discussed, once the identity of the patient is verified at step 103, the operator stationed at the central computer, and the patient in communication with the system, will then by-directionally communicate with one another by audio and video, so that the operator at the central computer can witness each step of the medication administering process.

At step 104, the automated medication adherence system initiates the medication administering process. The operator instructs the patient to place a medication container and/or an actual pill or other prescribed medication for the patient directly in front of the lens of the imaging device or camera. Once the prescribed medication is in clear view, the operator can remotely capture a current electronic photograph of the medication.

At step 105, the operator visually compares the current electronic photograph of the medication displayed by the patient with the currently prescribed medication listed in the patient's profile.

At step 106, if after making the visual comparison in step 105, the operator confirms that the medication displayed by the patient is the prescribed medication for the patient. At step 107, the patient is instructed to open pre-packaged medication, or allow the medication to drop or pour into a medicine cup. At step 108, the operator visually verifies appropriate quantities, dosage according to the prescription guidelines noted in the patient's profile.

Once the medication to be administered (and quantity) in accordance with the prescribed prescription regimen is confirmed by the operator, at step 110, the patient is prompted to administer the prescribed medication. At step 111, the operator observes the patient swallow the medication, or in instances when the patient is not to swallow but dissolve the medication, observe the patient until medication is dissolved.

It should be understood that for administering inhalant/nebulizing medications, rather than swallowing or dissolving the medication, the operator observes the patient placing the inhaler mouthpiece into the patient's mouth, and inhaling through the mouth while correctly manipulating the inhaler.

At step 112, the operator may verify that the patient has completed administering the prescribed medication. Such verification step may simply involve talking with the patient and notice, while the patient is talking, whether traces of a material (medication) may still be in the patient's mouth; or, asking the patient to simply open its mouth close to the camera allowing the operator to inspect inside the patient's mouth; or, if appropriate, instructing the patient to drink a glass of water, but before swallowing, instructing the patient to swish the water around in its mouth, and then swallow.

Again, it is important to note that during the entire administering process, including the steps of displaying the prescribed medication, separating the prescribed dosage, as well as administering the medication, and the steps of observing and verifying the patient completed the administering process, is all accomplished while the patient faces the imaging device or camera. And equally critical is that all acts or steps by the patient can be witnessed completely and continuously by the operator stationed at the central computer via the video call. As such, for purposes of compliance and integrity, during the entire administering session, neither the medication container nor the dosage is ever removed from the view of the camera and the operator stationed at the central computer. As such, while the prescribed medication is being administered by the patient, the medication remains in front of the camera until administered by the patient in step 110.

If at any time during the administering process, the prescribed medication is removed from the operator's view, the operator may instruct the patient to re-start the administering process at step 104.

The invention described herein includes a method of administering prescribed medication to a patient utilizing a method and system that allows for the automated administration of medication, and provides for a most sophisticated method for confirming medication adherence. The administering process disclosed provides an immediate verification and confirmation of medication adherence by visual analysis, and the result and patient data may be entered of record. Still further, it will be appreciated that embodiments of the disclosed invention provide a versatile system and method for confirming medication adherence programs designed for insuring compliance. The disclosed system offers important new and useful results in that it allows an entity to operate many remote stations at various locations, without having to have the remote stations networked together.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention,

Thus the scope of the invention should be determined by the appended claims in the formal application and their legal equivalence, rather than by these examples given.

1. A method of providing patient medication adherence in compliance with a medication prescription regimen over a network connection between a patient at a remote device and an operator at a central computer, said remote device and said central computer each comprising an imaging device such that the remote device can use its imaging device to bi-directionally communicate with the central computer's imaging device, said method comprising: establishing wireless communications between said remote device and said central computer; identifying the patient's medication to be administered; following instructions for administering the patients medication; and wherein said patient is facing the remote device's imaging device so that the operator can view the identifying, following and observing steps, and wherein the medication is in the operator's view until administered by the patient.

2. The method of claim 1, including the step of the operator verifying the patient has administered the medication after the administering step.

3. The method of claim 2, including the step of confirming the patient's medication is a prescribed medication.

4. The method of claim 3, including the step of storing a profile for said patient on the central computer, and wherein said patient's profile includes said patient's prescribed medication.

5. The method of claim 1, wherein the patients remote device is a mobile handheld wireless device.

6. The method of claim 1, further uploading software to establish said wireless communications in the form of an app.

7. The method as recited in claim 1, wherein the medication prescription regimen is provided by a medical professional.

8. The method as recited in claim 1, wherein the medication prescription regimen is in compliance with a court-ordered program.

9. A method for verifying a person's adherence with a medication regimen by visual analysis, said method comprising the following steps:
receiving a video feed over a network connection between a person at a remote
device and an operator at a central computer, said remote device and said
central computer each include an imaging device to bi-directionally communicate,
said operator viewing the person's current medication,
comparing the person's current medication with a prescribed medication listing stored in the central computer,
confirming that the person's current medication is on the prescribed medication listing,
preparing the person's current medication for administering,
verifying the person's prepared medication according to a guideline stored in the central computer,
observing the person administering the person's prepared medication,
said operator verifying the person has administered the person's prepared medication, wherein said person is facing the video camera at the remote device so that the person's current medication and prepared medication are in the operator's view until administered by the person.

10. The method of claim 9, wherein the person's prepared medication is a dosage of the person's current medication.

11. The method of claim 9, wherein the step of verifying the person has administered the person's prepared medication includes the step of generating a report verifying the person has administered the person's prepared medication.

12. The method as recited in claim 9, wherein the remote device is a mobile handheld wireless device.

13. The method as recited in claim 9, further uploading software to establish said network connection in the form of an app.

14. A method of providing patient medication adherence in compliance with a medication prescription regimen over a network connection between the patient at a remote device and an operator at a central computer, said remote device and said central computer each comprising an imaging device such that the remote device can use its imaging device to bi-directionally communicate with the central computer's imaging device, said method comprising: establishing wireless communications between said remote device and said central computer; establishing the patient's medication to be administered; said patient administering a dosage of said patient's medication; and wherein said patient is facing the remote device's imaging device so that the operator can view the establishing and administering steps, and wherein the patient's medication including said dosage is in the operator's view until administered by the patient.

15. The method as recited in claim 14, including the step of the operator verifying the patient has administered the dosage of the patient's medication.

16. The method as recited in claim 14, wherein the patient's remote device is a mobile handheld wireless device.

17. The method of claim 14, including the step of confirming the patient's medication is a prescribed medication.

18. The method of claim 14, including the step of storing a profile for said patient on the central computer, and wherein said patient's profile includes said prescribed medication.

19. The method of claim 14, further uploading software to establish said wireless communications in the form of an app.
